(19) United States
(12) Patent Application Publication
(10) Pub. No.: US 2026/0261385 A1
(43) Pub. Date: Sep. 3, 2026

(54) INFORMATION TERMINAL, COMMUNICATION METHOD, AND COMMUNICATION APPARATUS

(71) Applicant: Sony Semiconductor Solutions Corporation, Kanagawa (JP)

(72) Inventor: Hideya KITAYAMA, Kanagawa (JP)

(73) Assignee: Sony Semiconductor Solutions Corporation, Kanagawa (JP)

(21) Appl. No.: 18/881,790

(22) PCT Filed: Jul. 21, 2023
(86) PCT No.: PCT/JP2023/026799

§ 371 Date: Jan. 7, 2025

(30) Foreign Application Priority Data
Aug. 4, 2022 (JP) 2022-124937

(51) Int. Cl. H04L 5/00; H04L 43/062

(52) U.S. Cl. CPC H04L 5/0053; H04L 43/062

(57) ABSTRACT

The present technology relates to an information terminal, a communication method, and a communication apparatus that make it possible to improve a communication quality while preventing an increase in processing amount.

An information terminal of the present technology includes a receiver that receives a transmission signal transmitted by a single base station and addressed to a group that terminals including the information terminal belong to; and a transmitter that transmits, to the base station, a response signal that stores therein payload data included in the transmission signal, the response signal being receivable by the terminal belonging to the group and being other than the information terminal. The present technology can be applied to, for example, an IoT system used to collect information from a large number of sensor terminals to grasp an environmental change.

### TECHNICAL FIELD

The present technology relates to an information terminal, a communication method, and a communication apparatus, and in particular, to an information terminal, a communication method, and a communication apparatus that make it possible to improve a communication quality while preventing an increase in processing amount.

### BACKGROUND ART

There is an Internet-of-Things (IoT) communication system in which information acquired by a terminal provided to a person or an object is regularly transmitted by the terminal using wireless communication and the pieces of information are put together at a base station. For example, low-power wide-area (LPWA), which is a wireless communication scheme characterized by long-distance transmission and driving with low-power consumption, is used to perform communication between a base station and a terminal in the IoT communication system.

In the IoT communication system, downlink groupcast transmission in which a base station transmits the same signal to a plurality of terminals belonging to a single group is assumed to be performed. A signal transmitted using downlink groupcast transmission exhibits a different degree of quality when the signal is received by each terminal.

For example, Patent Literature 1 discloses a technology used to transfer a signal received by a certain terminal to another terminal. Using the technology disclosed in Patent Literature 1, a plurality of terminals belonging to a single group performs communication cooperatively, such as the case in which a terminal that was able to receive a signal with a greater quality than a specified threshold transfers the received signal to another terminal that was not able to receive the signal. This makes it possible to improve the quality of communication between a base station and each of the plurality of terminals.

### CITATION LIST

### Patent Literature

Patent Literature 1: Japanese Patent Application Laid-open No. 2015-211264

### DISCLOSURE OF INVENTION

### Technical Problem

When the technology disclosed in Patent Literature 1 is applied, communication between terminals is newly added to a sequence in addition to communication between a base station and each of the terminals, in order to avoid interference due to transfer. However, in a system using LPWA for which massively multiple access and ultra low power consumption are necessary, an increase in processing amount that is caused due to communication between terminals being added to a sequence is not desirable to both a base station and a terminal.

The present technology has been made in view of the circumstances described above and it is an object of the present technology to make it possible to improve a communication quality while preventing an increase in processing amount.

### Solution to Problem

An information terminal according to a first aspect of the present technology includes a receiver that receives a transmission signal transmitted by a single base station and addressed to a group that terminals including the information terminal belong to; and a transmitter that transmits, to the base station, a response signal that stores therein payload data included in the transmission signal, the response signal being receivable by the terminal belonging to the group and being other than the information terminal.

A communication method according to the first aspect of the present technology is performed by an information terminal, the communication method including receiving a transmission signal transmitted by a single base station and addressed to a group that terminals including the information terminal belong to; and transmitting, to the base station, a response signal that stores therein payload data included in the transmission signal, the response signal being receivable by the terminal belonging to the group and being other than the information terminal.

A communication apparatus according to a second aspect of the present technology includes a transmitter that transmits a transmission signal to a group that terminals belong to; and a receiver that receives a response signal that is a signal transmitted by one of the terminals belonging to the group, the response signal storing therein payload data included in the transmission signal, the response signal being receivable by the terminal belonging to the group and being other than the one of the terminals.

In the first aspect of the present technology, a transmission signal transmitted by a single base station and addressed to a group that terminals including the information terminal belong to is received; and a response signal that stores therein payload data included in the transmission signal is transmitted to the base station, the response signal being receivable by the terminal belonging to the group and being other than the information terminal.

In the second aspect of the present technology, a transmission signal is transmitted to a group that terminals belong to; and a response signal that is a signal transmitted by one of the terminals belonging to the group is received, the response signal storing therein payload data included in the transmission signal, the response signal being receivable by the terminal belonging to the group and being other than the one of the terminals.

### BRIEF DESCRIPTION OF DRAWINGS

FIG. 1 illustrates an example of a configuration of a communication system according to an embodiment of the present technology.

FIG. 2 illustrates how communication is performed between a sensor terminal and a communication apparatus.

FIG. 3 illustrates examples of configurations of a transmission signal and an ACK signal.

FIG. 4 illustrates examples of pieces of information respectively necessary for a subordinate terminal and the communication apparatus.

FIG. 5 is a timing chart illustrating operations of a base station and the sensor terminal in downlink groupcast transmission.

FIG. 6 illustrates an example of a frame format of a transmission signal.

FIG. 7 is a block diagram of an example of a configuration of the sensor terminal.

FIG. 8 is a block diagram of an example of a configuration of the communication apparatus.

FIG. 9 is a flowchart used to describe processing performed by a representative terminal.

FIG. 10 is a flowchart used to describe processing performed by a subordinate terminal.

FIG. 11 is a flowchart used to describe processing performed by the communication apparatus.

FIG. 12 is a block diagram of an example of a configuration of hardware.

### MODE(S) FOR CARRYING OUT THE INVENTION

Embodiments for carrying out the present technology are described below. The description is made in the following order.
1. Overview of Communication System
2. Configuration of Each Apparatus
3. Operation of Each Apparatus
4. Modifications

### <1. Overview of Communication System>

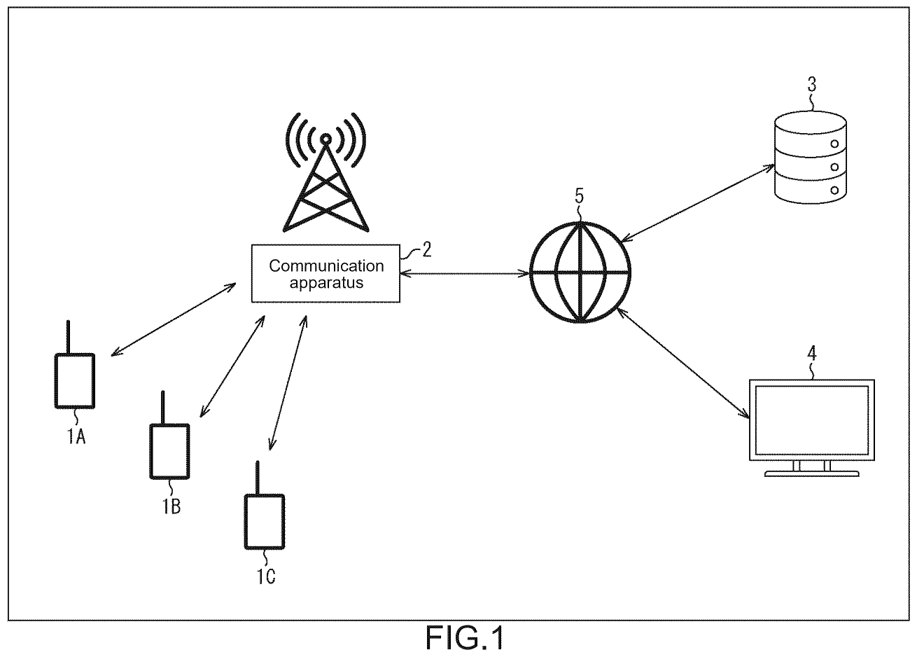

FIG. 1 illustrates an example of a configuration of a communication system according to an embodiment of the present technology.

The communication system illustrated in FIG. 1 is, for example, an Internet-of-Things (IoT) communication system that is used to grasp chronological changes in distributions of, for example, a temperature and humidity at an installation location of each one of a plurality of sensor terminals arranged over a wide range, on the basis of information acquired by the sensor terminal. The communication system includes sensor terminals 1A to 1C, a communication apparatus 2 in a base station, a server 3, a display apparatus 4, and a network 5.

Each of the sensor terminals 1A to 1C and the communication apparatus 2 are connected to each other using wireless communication. For example, low-power wide-area (LPWA), which is a wireless communication scheme characterized by long-distance transmission and driving with low-power consumption, is used to perform wireless communication between each of the sensor terminals 1A to 1C and the communication apparatus 2. The communication apparatus 2, the server 3, and the display apparatus 4 are connected to each other through the network 5. Note that the communication apparatus 2, the server 3, and the display apparatus 4 may communicate with each other wirelessly or by wire.

The sensor terminals 1A to 1C are devices that are managed by a single manager and that belong to a single group. For example, each of the sensor terminals 1A to 1C is what is called an IoT device that includes at least one sensor. Each of the sensor terminals 1A to 1C is provided to, for example, a person or an object, and performs sensing on a surrounding environment using, for example, a camera, a microphone, a temperature sensor, a humidity sensor, an oscillation sensor, an optical sensor, and an atmospheric-pressure sensor.

Each of the sensor terminals 1A to 1C transmits sensor data to the communication apparatus 2, for example, periodically, the sensor data representing a sensing result. Further, each of the sensor terminals 1A to 1C receives a transmission signal that is a signal transmitted by the communication apparatus 2, and transmits, to the communication apparatus 2, an acknowledge (ACK) signal as a response signal that is a signal transmitted by the sensor terminal after the transmission signal is received. The ACK signal is a signal used to report to the base station that reception of a transmission signal has been completed normally.

Note that the number of sensor terminals connected to the communication apparatus 2 is not limited to three, and more sensor terminals are actually connected to the communication apparatus 2. The sensor terminals 1A to 1C are hereinafter simply referred to as sensor terminals 1 when there is no need to distinguish among the sensor terminals 1A to 1C.

The communication apparatus 2 is provided to a base station. The communication apparatus 2 receives sensor data transmitted by the sensor terminal 1, and supplies the sensor data to the server 3.

Further, the communication apparatus 2 performs downlink groupcast transmission in which the same transmission signal is transmitted to a plurality of sensor terminals 1 belonging to a single group. When the communication apparatus 2 receives an ACK signal transmitted by the sensor terminal 1 corresponding to a transmission destination of the transmission signal, the communication apparatus 2 determines that transmission of the transmission signal to the group has been completed.

The server 3 is an information processing apparatus that manages information transmitted between the sensor terminal 1 and the communication apparatus 2. The server 3 stores therein, for example, sensor data supplied by the communication apparatus 2. The server 3 causes, for example, the sensor data and whether downlink groupcast transmission has been completed to be displayed on the display apparatus 4 in response to, for example, a request to the communication system being made by a user.

Under the control of the server 3, the display apparatus 4 displays thereon the sensor data of the sensor terminal 1 and whether downlink groupcast transmission has been completed to present the displayed pieces of information to the user.

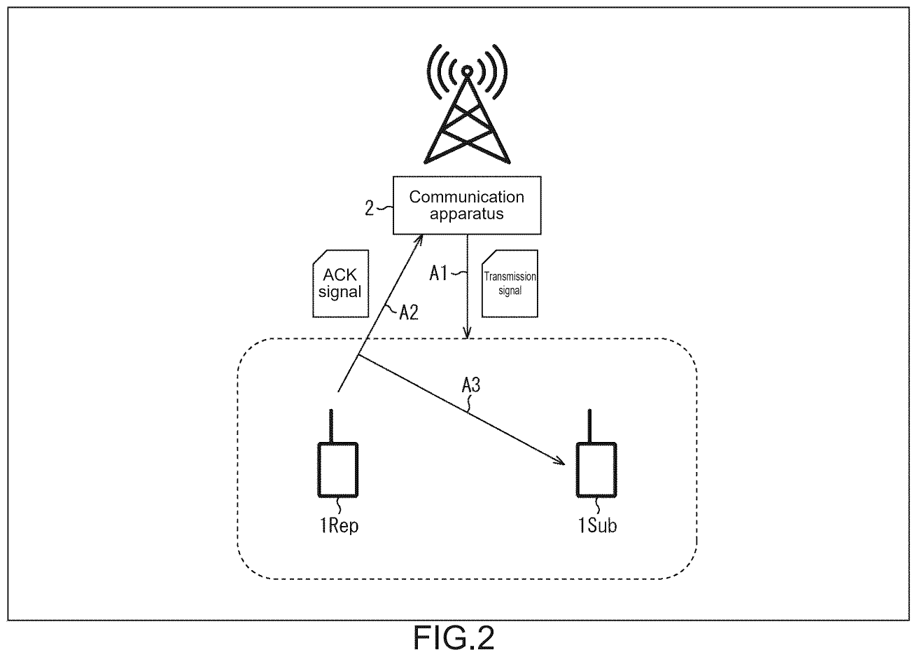

Next, a method for communication between the sensor terminal 1 and the communication apparatus 2 is described in detail with reference to FIGS. 2 to 5.

FIG. 2 illustrates how communication is performed between the sensor terminal 1 and the communication apparatus 2.

First, the communication apparatus 2 transmits a transmission signal to a group that a plurality of sensor terminals 1 belongs to, as indicated by an arrow A1 in FIG. 2.

In the example illustrated in FIG. 2, two sensor terminals 1Rep and 1Sub boxed in using a dashed line belong to a single group. From among a plurality of sensor terminals 1 belonging to a single group, a terminal that transmits an ACK signal is referred to as a representative terminal, and a terminal other than the representative terminal is referred to as a subordinate terminal. The sensor terminal 1Rep is hereinafter also referred to as a representative terminal 1Rep, and the sensor terminal 1Sub is hereinafter also referred to as a subordinate terminal 1Sub.

For example, the sensor terminals 1 used by a single service contractor belong to a single group. Further, the sensor terminals 1 may be classified into groups of respective classes such as a high-class group and a low-class group. For example, the class of the sensor terminal 1 is determined on the basis of at least one of the type of sensor terminal 1 or a function of the sensor terminal 1.

Note that, from the sensor terminals 1 belonging to a group, the representative terminal is selected by a manager of the communication system or the sensor terminal 1 through the communication apparatus 2 when, for example, the group is formed. The representative terminal may be dynamically selected by the communication apparatus 2 on the basis of a quantitative feature amount such as the strength of signal reception of each sensor terminal 1 or the remaining capacity of a power source of each sensor terminal 1. For example, from a plurality of sensor terminals 1 belonging to a single group, the sensor terminal 1 having a greatest strength of reception of a transmission signal or the sensor terminal 1 of which the power source has a highest remaining capacity is selected as the representative terminal. A plurality of sensor terminals 1 may be selected as the representative terminals in a single group.

Next, the representative terminal 1Rep receives a transmission signal transmitted by the communication apparatus 2, and transmits an ACK signal to the base station, as indicated by an arrow A2 in FIG. 2.

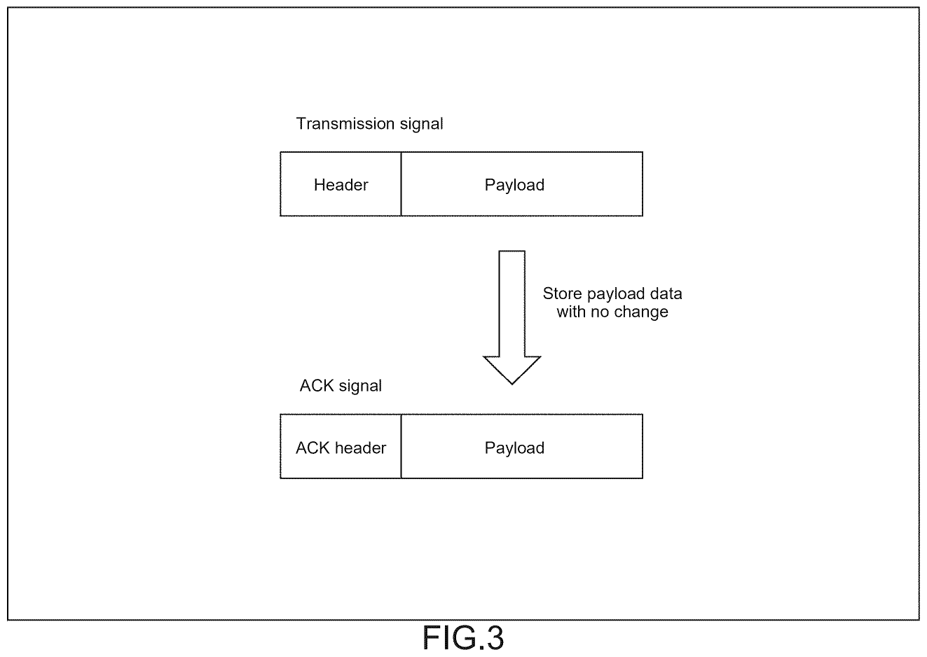

FIG. 3 illustrates examples of configurations of a transmission signal and an ACK signal.

As illustrated in an upper portion of FIG. 3, a transmission signal includes a header and a payload. The header of the transmission signal stores therein, as header information, identification information (an identifier (ID)) used to identify a base station corresponding to a transmission source of the transmission signal, and an ID of the sensor terminal 1 belonging to a group corresponding to a transmission destination of the transmission signal. The payload of the transmission signal stores therein, as payload data, any information (user data) that the base station desires to transmit to the sensor terminal 1.

As illustrated in a lower portion of FIG. 3, an ACK signal includes an ACK header and a payload. The ACK header of the ACK signal stores therein, as header information, an ID used to identify a group that an ACK signal transmitting terminal (the representative terminal 1Rep) belongs to, an identifier of the representative terminal (such as an ID of the ACK signal transmitting terminal), and a flag indicating that a signal including an ACK header is an ACK signal. The payload of the ACK signal stores therein, with no change, user data (payload data) stored in a payload of a transmission signal received by the representative terminal 1Rep.

Returning to FIG. 2, the subordinate terminal 1Sub receives a transmission signal transmitted by the communication apparatus 2. When the subordinate terminal 1Sub fails to receive the transmission signal, the subordinate terminal 1Sub receives an ACK signal transmitted by the representative terminal 1Rep belonging to a group that the subordinate terminal 1Sub belongs to, and tries to acquire the transmission signal (user data) again, as indicated by an arrow A3 in FIG. 2.

Next, the communication apparatus 2 receives an ACK signal transmitted by the representative terminal 1Rep. At a timing of receiving the ACK signal transmitted by the representative terminal 1Rep, the communication apparatus 2 determines that transmission of a transmission signal to a group that the representative terminal 1Rep belongs to has been completed normally.

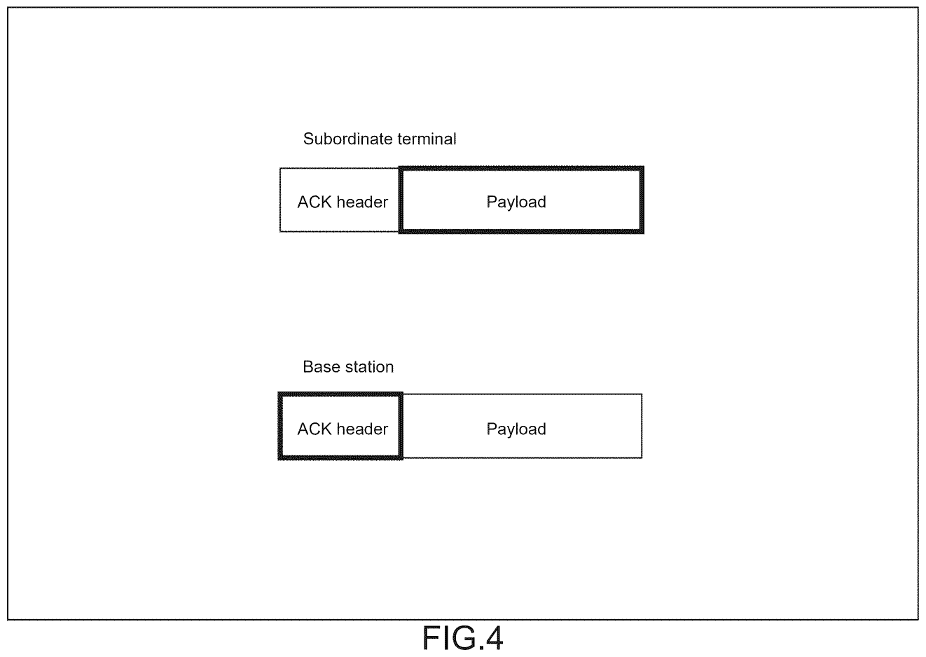

FIG. 4 illustrates examples of pieces of information respectively necessary for the subordinate terminal 1Sub and the communication apparatus 2.

Payload data that is from among information included in an ACK signal and stored in a payload is information necessary for the subordinate terminal 1Sub, as indicated by being boxed in using a bold line in an upper portion of FIG. 4.

On the basis of header information included in an ACK signal received by the subordinate terminal 1Sub, the subordinate terminal 1Sub confirms that the received ACK signal is an ACK signal transmitted by another sensor terminal 1 that belongs to a group that the subordinate terminal 1Sub belongs to. Thereafter, the subordinate terminal 1Sub acquires payload data from the received ACK signal. The payload of the ACK signal stores therein, with no change, user data included in a transmission signal. Thus, the subordinate terminal 1Sub can acquire user data from the ACK signal even if the subordinate terminal 1Sub fails to receive the transmission signal.

Header information that is from among information included in an ACK signal and stored in an ACK header is information necessary for the communication apparatus 2 (the base station), as indicated by being boxed in using a bold line in a lower portion of FIG. 4. On the basis of, for example, header information included in an ACK signal received by the communication apparatus 2, the communication apparatus 2 can specify a group that the representative terminal 1Rep corresponding to a transmission source of the received ACK signal belongs to, and can determine that transmission of a transmission signal to the group has been completed normally.

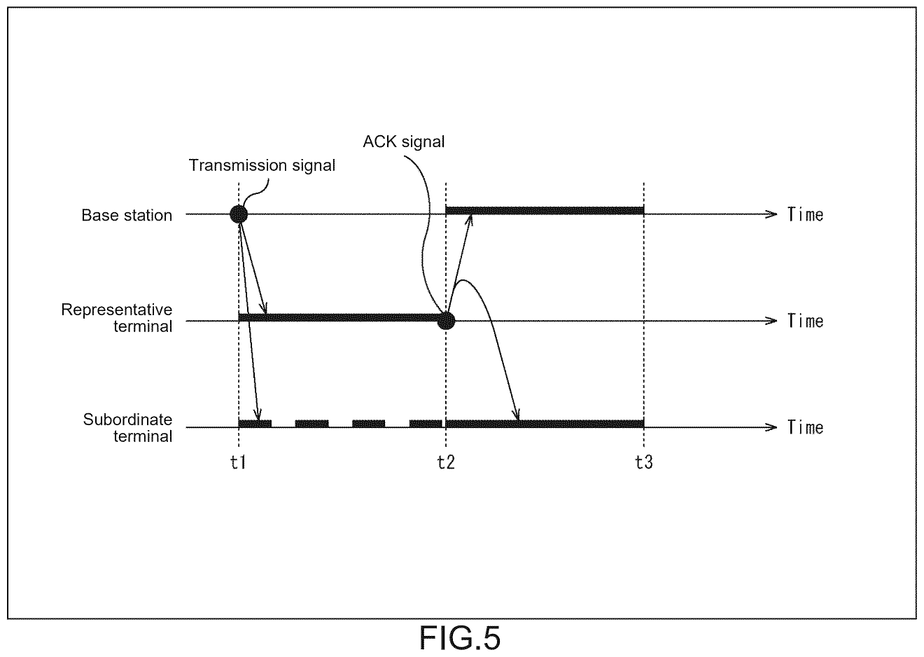

FIG. 5 is a timing chart illustrating operations of the base station and the sensor terminal 1 in downlink groupcast transmission.

As illustrated in FIG. 5, the communication apparatus 2 (the base station) transmits, at a time t1, a transmission signal to a group that the representative terminal 1Rep and the subordinate terminal 1Sub belong to.

For a period of time from the time t1 to a time t2, the representative terminal 1Rep normally receives the transmission signal transmitted by the communication apparatus 2. Further, it is assumed that, for the period of time from the time t1 to the time t2, the subordinate terminal 1Sub fails to receive the transmission signal transmitted by the communication apparatus 2. In FIG. 5, a bold solid line indicates that a signal is received normally, and a bold dashed line indicates that a signal is not received.

At the time t2, the representative terminal 1Rep stores, in an ACK signal, payload data included in the transmission signal, and transmits the ACK signal to the base station.

For a period of time from the time t2 to a time t3, the communication apparatus 2 normally receives the ACK signal transmitted by the representative terminal 1Rep, and the subordinate terminal 1Sub also normally receives the ACK signal transmitted by the representative terminal 1Rep.

A transmission signal transmitted using downlink groupcast transmission exhibits a different degree of quality when the transmission signal is received by each sensor terminal 1, such as the case in which the transmission signal is received normally by the representative terminal 1Rep but is not received by the subordinate terminal 1Sub.

Conventionally, a plurality of sensor terminals belonging to a single group performs communication cooperatively using a technology used to transfer a signal received by a certain sensor terminal to another sensor terminal, such as the case in which a certain sensor terminal that has received a signal with a quality greater than a specified threshold transfers the received signal to another sensor terminal that has failed to receive the signal. This makes it possible to improve the quality of communication between a base station and a sensor terminal.

When existing technologies are applied, communication between sensor terminals is newly added to a sequence in addition to communication between a base station and each of the terminals, in order to avoid interference due to transfer. It is not a problem if communication between sensor terminals is added to a sequence in a communication system, such as a system in which the sensor terminal is, for example, a cellular phone, that has sufficient processing capability and sufficient electric power. On the other hand, in a system using LPWA for which massively multiple access and ultra low power consumption are necessary, an increase in processing amount that is caused due to communication between sensor terminals being added to a sequence is not desirable to both a base station and a sensor terminal.

When the communication system of the present technology is applied, the representative terminal 1Rep receiving a transmission signal transmitted by a base station and addressed to a group that a plurality of sensor terminals 1 including the representative terminal 1Rep belongs to, transmits an ACK signal to the base station, where the ACK signal stores therein, with no change, payload data included in the transmission signal and can be received by the sensor terminal 1 belonging to the group and being other than the representative terminal 1Rep. The subordinate terminal 1Sub can acquire the payload data included in the transmission signal by receiving the ACK signal transmitted by the representative terminal 1Rep.

The subordinate terminal 1Sub can acquire payload data included in a transmission signal from an ACK signal even if the subordinate terminal 1Sub fails to receive the transmission signal. This makes it possible to reduce the number of sensor terminals 1 failing to receive payload data included in a transmission signal.

When existing communication systems are applied, it is necessary that processing of retransmitting a transmission signal be performed by a base station if there is a sensor terminal that has failed in receiving the transmission signal. On the other hand, the communication system of the present technology makes it possible to cause transmission of an ACK signal by the representative terminal 1Rep to play a role in retransmitting a transmission signal.

When transmission of an ACK signal plays a role in transmitting a transmission signal, this makes it possible to reduce a processing amount related to retransmission of a transmission signal by a base station, without adding processing of transferring the transmission signal to an existing communication sequence. When a processing amount related to retransmission of a transmission signal by a base station is reduced, this results in a base station having extra processing capacity. This makes it possible to increase the number of sensor terminals 1 connected to a single base station.

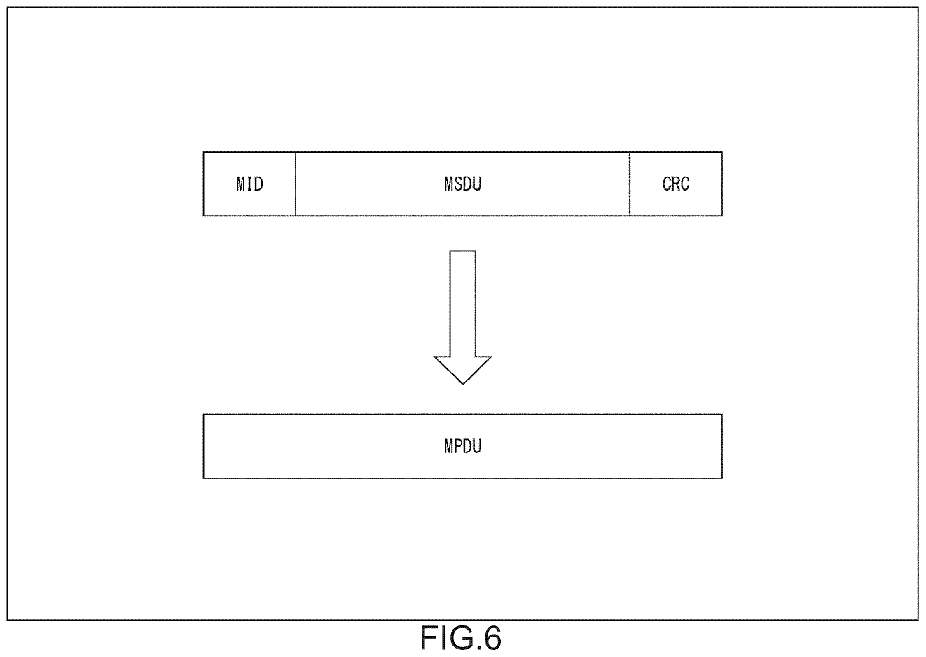

FIG. 6 illustrates an example of a frame format of a transmission signal.

For example, a transmission signal is transmitted in the form of MPDUs including MID, MSDU, and CRC, as illustrated in FIG. 6.

When the communication system is designed such that a transmission signal is transmitted in the form of MPDUs, the representative terminal 1Rep stores an ID of the group and an identifier of the representative terminal 1Rep in a portion of MID as header information, and copies MSDU and CRC from the transmission signal. Accordingly, the representative terminal 1Rep generates an ACK signal.

### <2. Configuration of Each Apparatus>

### Configuration of Sensor Terminal 1

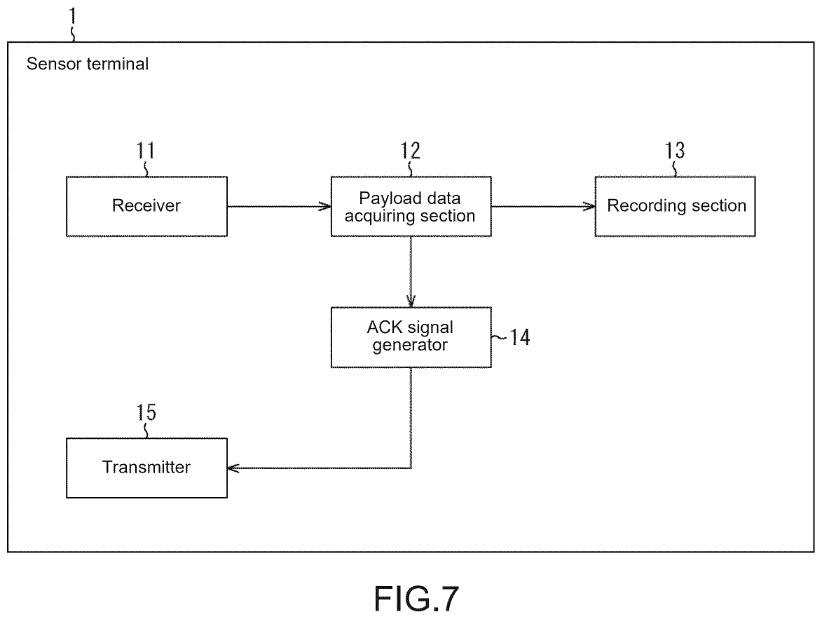

FIG. 7 is a block diagram of an example of a configuration of the sensor terminal 1.

As illustrated in FIG. 7, the sensor terminal 1 includes a receiver 11, a payload data acquiring section 12, a recording section 13, an ACK signal generator 14, and a transmitter 15.

The receiver 11 receives a transmission signal transmitted by the communication apparatus 2, and supplies the received transmission signal to the payload data acquiring section 12. Further, the receiver 11 receives an ACK signal transmitted by another sensor terminal 1 belonging to a group that the sensor terminal 1 of the receiver 11 belongs to, and supplies the received ACK signal to the payload data acquiring section 12.

The payload data acquiring section 12 acquires payload data from a payload of the transmission signal supplied by the receiver 11, and supplies the payload data to the recording section 13 and the ACK signal generator 14. Further, the payload data acquiring section 12 acquires payload data from a payload of the ACK signal supplied by the receiver 11, and supplies the payload data to the recording section 13.

The recording section 13 records therein the payload data supplied by the payload data acquiring section 12.

The ACK signal generator 14 stores, in a payload, the payload data supplied by the payload data acquiring section 12, and stores header information in an ACK header. Accordingly, the ACK signal generator 14 generates an ACK signal. The ACK signal generator 14 supplies the generated ACK signal to the transmitter 15.

When the sensor terminal 1 of the transmitter 15 is a representative terminal, the transmitter 15 transmits, to a base station, the ACK signal supplied by the ACK signal generator 14.

### Configuration of Communication Apparatus 2

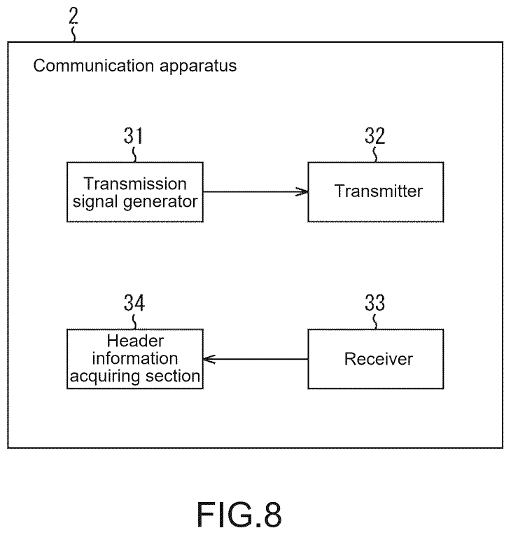

FIG. 8 is a block diagram of an example of a configuration of the communication apparatus 2.

As illustrated in FIG. 8, the communication apparatus 2 includes a transmission signal generator 31, a transmitter 32, a receiver 33, and a header information acquiring section 34.

The transmission signal generator 31 generates a transmission signal including user data, and supplies the generated transmission signal to the transmitter 32.

The transmitter 32 transmits the transmission signal to a group that a plurality of sensor terminals 1 belongs to, the transmission signal being supplied by the transmission signal generator 31.

The receiver 33 receives an ACK signal transmitted by the sensor terminal 1, and supplies the received ACK signal to the header information acquiring section 34.

The header information acquiring section 34 acquires header information from a header of the ACK signal supplied by the receiver 33. The header information acquiring section 34 also serves as a transmission determination section that specifies, on the basis of the header information, a group that the sensor terminal 1 corresponding to a transmission source of the received ACK signal belongs to, and that determines that transmission of a transmission signal to the group has been completed normally.

### <3. Operation of Each Apparatus>

### Operation of Representative Terminal 1Rep

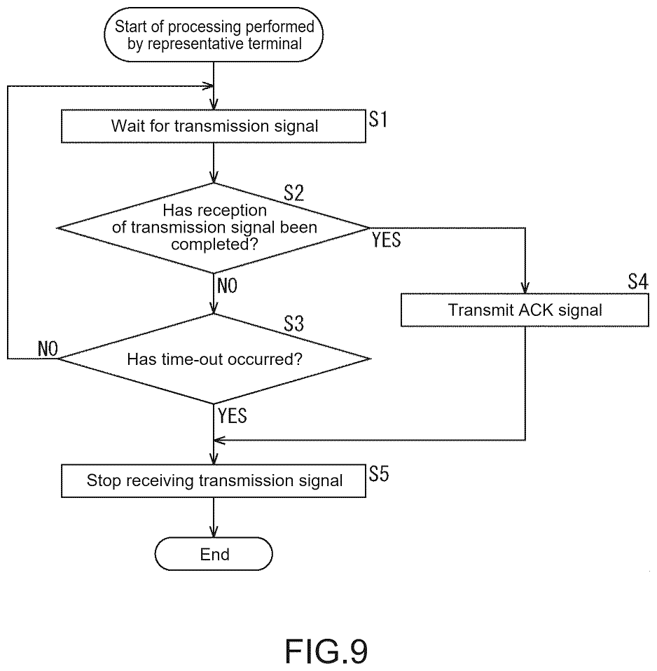

Next, processing performed by the representative terminal 1Rep is described with reference to a flowchart of FIG. 9.

In Step S1, the receiver 11 waits for a transmission signal to be transmitted by the communication apparatus 2. When the transmission signal is transmitted by the communication apparatus 2, the receiver 11 receives the transmission signal, and the payload data acquiring section 12 acquires payload data from a payload of the transmission signal.

In Step S2, the receiver 11 determines whether the reception of the transmission signal transmitted by the communication apparatus 2 has been completed normally.

When it has been determined, in Step S2, that the reception of the transmission signal has not been completed normally, the process moves on to Step S3, and the receiver 11 determines whether time-out has occurred. For example, it has been determined that time-out has occurred when a specified period of time has elapsed since the wait for the transmission signal was started.

When it has been determined, in Step S3, that time-out has not occurred, the process returns to Step S1, and a state of waiting for the transmission signal to be transmitted by the communication apparatus 2 is maintained.

On the other hand, when it has been determined, in Step S2, that the reception of the transmission signal has been completed normally, the process moves on to Step S4, the ACK signal generator 14 stores, in a payload, payload data included in the transmission signal to generate an ACK signal, and the transmitter 15 transmits the ACK signal to the base station. For example, the transmitter 15 repeatedly transmits the ACK signal the specified number of times.

After the ACK signal is transmitted in Step S4, or when it has been determined, in Step S3, that time-out has occurred, the process moves on to Step S5, and the receiver 11 stops the operation of receiving the transmission signal.

### Operation of Subordinate Terminal 1Sub

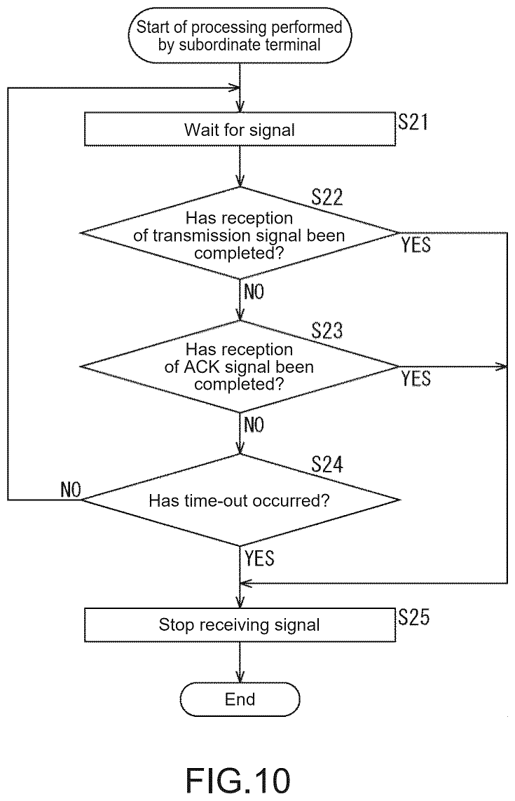

Next, processing performed by the subordinate terminal 1Sub is described with reference to a flowchart of FIG. 10.

In Step S21, the receiver 11 waits for a signal to be transmitted by the communication apparatus 2 or the representative terminal 1Rep. When a transmission signal is transmitted by the communication apparatus 2, the receiver 11 receives the transmission signal, and the payload data acquiring section 12 acquires payload data from a payload of the transmission signal. When an ACK signal is transmitted by the representative terminal 1Rep, the receiver 11 receives the ACK signal, and the payload data acquiring section 12 acquires payload data from a payload of the ACK signal.

In Step S22, the receiver 11 determines whether the reception of the transmission signal transmitted by the communication apparatus 2 has been completed normally.

When it has been determined, in Step S22, that the reception of the transmission signal has not been completed normally, the process moves on to Step S23, and the receiver 11 determines whether the reception of the ACK signal transmitted by the representative terminal 1Rep has been completed normally.

When it has been determined, in Step S23, that the reception of the ACK signal has not been completed normally, the process moves on to Step S24, and the receiver 11 determines whether time-out has occurred. For example, it has been determined that time-out has occurred when a specified period of time has elapsed since the wait for the signal was started.

When it has been determined, in Step S24, that time-out has not occurred, the process returns to Step S21, and a state of waiting for the signal to be transmitted by the communication apparatus 2 or the representative terminal 1Rep is maintained.

On the other hand, when it has been determined, in Step S22, that the reception of the transmission signal has been completed normally, or when it has been determined, in Step S23, that the reception of the ACK signal has been completed normally, or when it has been determined, in Step S24, that time-out has occurred, the process moves on to Step S25, and the receiver 11 stops the operation of receiving the signal.

Note that, when the subordinate terminal 1Sub has normally received a transmission signal transmitted by the communication apparatus 2, the subordinate terminal 1Sub can also transmit an ACK signal to the representative terminal 1Rep or the base station. The ACK signal transmitted by the subordinate terminal 1Sub may store therein payload data included in the transmission signal, or does not necessarily have to store therein the payload data. When the sensor terminals 1 are situated close to each other and there may be overcrowding with ACK signals, the number of subordinate terminals 1Sub transmitting an ACK signal may be reduced.

Further, when the subordinate terminal 1Sub has normally received an ACK signal transmitted by the representative terminal 1Rep, the subordinate terminal 1Sub can also transmit an ACK signal to the representative terminal 1Rep or the base station.

On the basis of an ACK signal transmitted by the subordinate terminal 1Sub, the representative terminal 1Rep can determine a timing of terminating transmission of an ACK signal that stores therein payload data included in a transmission signal. When, for example, the number of subordinate terminals 1Sub belonging to a group that the representative terminal 1Rep belongs to is known to the representative terminal 1Rep, the representative terminal 1Rep transmits an ACK signal repeatedly until ACK signals are transmitted to the representative terminal 1Rep from all of the subordinate terminals 1Sub belonging to the group that the representative terminal 1Rep belongs to.

### Operation of Communication Apparatus 2

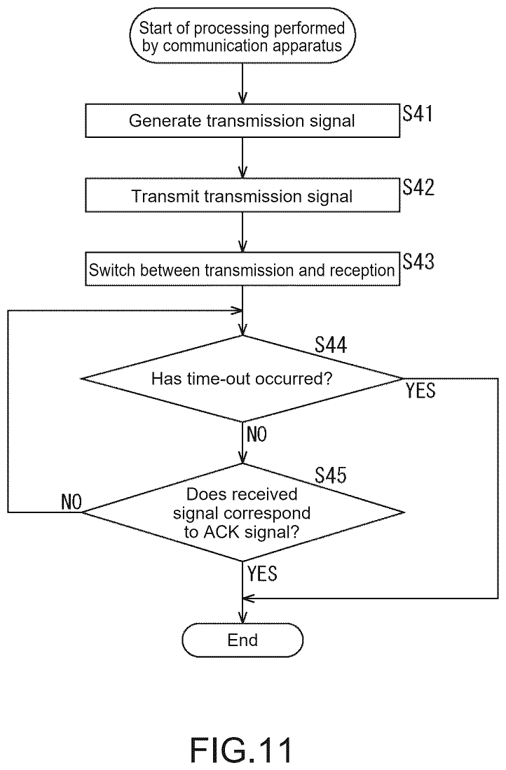

Next, processing performed by the communication apparatus 2 is described with reference to a flowchart of FIG. 11.

In Step S41, the transmission signal generator 31 stores user data in a payload to generate a transmission signal.

In Step S42, the transmitter 32 transmits the transmission signal to a group that a plurality of sensor terminals 1 belongs to.

In Step S43, the communication apparatus 2 switches between transmission and reception of a signal. Specifically, the receiver 33 waits for a signal to be transmitted by the sensor terminal 1. When a signal is transmitted by the sensor terminal 1, the receiver 33 receives the signal, and the header information acquiring section 44 acquires header information from a header of the signal.

In Step S44, the receiver 33 determines whether time-out has occurred. For example, it has been determined that time-out has occurred when a specified period of time has elapsed since switching between transmission and reception of a signal was performed.

When it has been determined, in Step S44, that time-out has not occurred, the process moves on to Step S45, and the header information acquiring section 34 determines whether the received signal is an ACK signal, on the basis of the header information.

When it has been determined, in Step S45, that the received signal is not an ACK signal, the process returns to Step S44, and a state of waiting for a signal to be transmitted by the sensor terminal 1 is maintained until time-out occurs.

On the other hand, when it has been determined, in Step S45, that the received signal is an ACK signal, the header information acquiring section 34 determines that transmission of a transmission signal to a group that the sensor terminal 1 corresponding to a transmission source of the received ACK signal belongs to has been completed normally, and the processing is terminated. When it has been determined, in Step S44, that time-out has occurred, the processing is also terminated.

Note that, when not only the representative terminal 1Rep but also the subordinate terminal 1Sub transmits an ACK signal, determination of whether a transmission source of an ACK signal is a representative terminal is added after it is determined, in Step S45, that a received signal is the ACK signal. Whether a transmission source of an ACK signal is a representative terminal is determined by the header information acquiring section 44 on the basis of header information.

When it has been determined, in the added determination, that the transmission source of an ACK signal is a subordinate terminal, the process returns to Step S44, and the state of waiting for a signal to be transmitted by the sensor terminal 1 is maintained until time-out occurs. On the other hand, when it has been determined, in the added determination, that the transmission source of an ACK signal is a representative terminal, the header information acquiring section 34 determines that transmission of a transmission signal to a group that the sensor terminal 1 corresponding to a transmission source of the received ACK signal belongs to has been completed normally, and the processing is terminated.

According to the processing described above, the subordinate terminal 1Sub receives an ACK signal transmitted by the representative terminal 1Rep, and this enables the subordinate terminal 1Sub to acquire payload data included in a transmission signal transmitted by the communication apparatus 2 even if the subordinate terminal 1Sub fails to receive the transmission signal.

An existing communication sequence includes processing of transmitting, to a base station, an ACK signal that does not store therein payload data included in a transmission signal when the transmission signal is received normally. In the communication system of the present technology, payload data included in a transmission signal is stored in an ACK signal, and this makes it possible to reduce the number of sensor terminals 1 failing to acquire payload data included in a transmission signal and to improve the quality of communication between a base station and the sensor terminal 1, without adding, to the existing communication sequence, processing of transferring the transmission signal.

### <4. Modifications>

Instead of being stored in an ACK signal transmitted from the sensor terminal 1 to a base station, payload data included in a transmission signal may be stored in another signal transmitted from the sensor terminal 1 to the base station. For example, payload data included in a transmission signal is stored in a communication request signal or a connection confirmation requesting signal (typically, SYN or SEQ).

The present technology can be applied not only to a communication system using LPWA but also to a wireless communication system using another communication scheme such as a cellular phone line or a wireless local area network (WLAN).

### Regarding Computer

The series of processes described above can be performed using hardware or software. When the series of processes is performed using software, a program included in the software is installed from a program recording medium on, for example, a computer incorporated into dedicated hardware or a general-purpose personal computer.

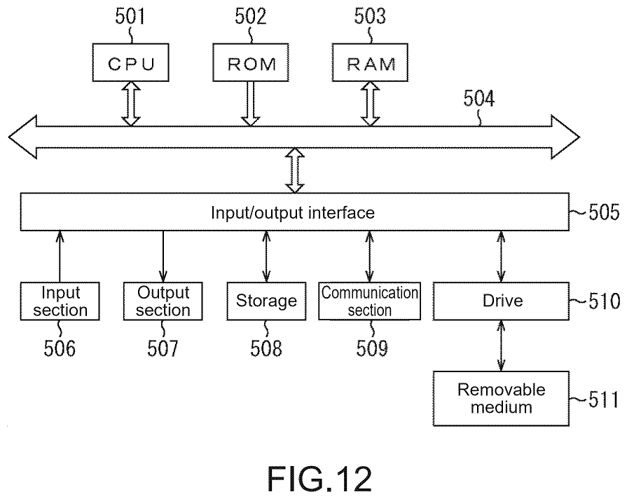

FIG. 12 is a block diagram of an example of a configuration of hardware of a computer that performs the series of processes described above using a program. For example, the sensor terminal 1, the communication apparatus 2, the server 3, and the display apparatus 4 each include a PC having a configuration similar to the configuration illustrated in FIG. 12.

A central processing unit (CPU) 501, a read only memory (ROM) 502, and a random access memory (RAM) 503 are connected to each other through a bus 504.

Further, an input/output interface 505 is connected to the bus 504. An input section 506 that includes, for example, a keyboard and a mouse, and an output section 507 that includes, for example, a display and a speaker are connected to the input/output interface 505. Further, a storage 508 that includes, for example, a hard disk and a nonvolatile memory, a communication section 509 that includes, for example, a network interface, and a drive 510 that drives a removable medium 511 are connected to the input/output interface 505.

In a computer having the configuration described above, the series of processes described above is performed by the CPU 501 loading, for example, a program stored in the storage 508 into the RAM 503 and executing the program via the input/output interface 505 and the bus 504.

For example, the program executed by the CPU 501 is provided by being recorded in the removable medium 511 or provided via a wired or wireless transmission medium such as a local area network, the Internet, or digital broadcasting, and the provided program is installed on the storage 508.

The program executed by the computer may be a program in which processes are chronologically performed in the order of the description herein, or may be a program in which processes are performed in parallel or a process is performed at a necessary timing such as a timing of calling.

Note that the system as used herein refers to a collection of a plurality of components (such as apparatuses and modules (parts)) and it does not matter whether all of the components are in a single housing. Thus, a plurality of apparatuses accommodated in separate housings and connected to one another via a network, and a single apparatus in which a plurality of modules is accommodated in a single housing are both systems.

Note that the effects described herein are not limitative but are merely illustrative, and other effects may be provided.

The embodiments of the present technology are not limited to the examples described above, and various modifications may be made thereto without departing from the scope of the present technology.

Further, the respective steps described using the flowcharts described above may be performed by a single apparatus, or may be shared to be performed by a plurality of apparatuses.

Moreover, when a single step includes a plurality of processes, the plurality of processes included in the single step may be performed by a single apparatus, or may be shared to be performed by a plurality of apparatuses.

### Examples of Combination of Configurations

The present technology may also take the following configurations.
(1) An information terminal, including:
   a receiver that receives a transmission signal transmitted by a single base station and addressed to a group that terminals including the information terminal belong to; and
   a transmitter that transmits, to the base station, a response signal that stores therein payload data included in the transmission signal, the response signal being receivable by the terminal belonging to the group and being other than the information terminal.
(2) The information terminal according to (1), in which
   the response signal is a signal used to report to the base station that the transmission signal has been received normally.
(3) The information terminal according to (1) or (2), in which
   the response signal includes information used to identify the group.
(4) The information terminal according to any one of (1) to (3), in which
   when the information terminal is a representative one of the terminals belonging to the group, the transmitter transmits the response signal to the base station.
(5) The information terminal according to (4), in which the response signal includes information used to identify the information terminal corresponding to the representative terminal.
(6) The information terminal according to (4) or (5), in which
   when the group is formed, the representative terminal is selected from the terminals belonging to the group, or
   on the basis of at least one of strength of signal reception of each of the terminals belonging to the group, or the remaining capacity of a power source of each of the terminals belonging to the group, the representative terminal is selected from the terminals belonging to the group.
(7) The information terminal according to any one of (1) to (6), in which
   when the receiver fails to receive the transmission signal transmitted by the base station, the receiver receives the response signal addressed to the base station and transmitted by the terminal belonging to the group and being other than the information terminal.
(8) The information terminal according to any one of (1) to (7), in which
   the transmission signal includes information used to identify the base station.
(9) The information terminal according to any one of (1) to (8), in which
   the transmission signal includes information used to identify the terminal belonging to the group.
(10) The information terminal according to any one of (1) to (9), in which
   the terminals used by a single service contractor belong to the group.
(11) The information terminal according to any one of (1) to (9), in which
   the terminals are classified into the groups of respective classes determined on the basis of at least one of the type of the terminal or a function of the terminal.
(12) A communication method that is performed by an information terminal, the communication method including:
   receiving a transmission signal transmitted by a single base station and addressed to a group that terminals including the information terminal belong to; and transmitting, to the base station, a response signal that stores therein payload data included in the transmission signal, the response signal being receivable by the terminal belonging to the group and being other than the information terminal.
(13) A communication apparatus, including:
   a transmitter that transmits a transmission signal to a group that terminals belong to; and
   a receiver that receives a response signal that is a signal transmitted by one of the terminals belonging to the group, the response signal storing therein payload data included in the transmission signal, the response signal being receivable by the terminal belonging to the group and being other than the one of the terminals.
(14) The communication apparatus according to (13), further including
   a transmission determination section that determines, when the response signal transmitted by the one of the terminals belonging to the group is received, that the transmission of the transmission signal to the group has been completed normally.

### Reference Signs List

1 sensor terminal
1Rep representative terminal
1Sub subordinate terminal
2 communication apparatus
3 server
4 display apparatus
5 network
11 receiver
12 payload data acquiring section
13 recording section
14 ACK signal generator
15 transmitter
31 transmission signal generator
32 transmitter
33 receiver
34 header information acquiring section

1. An information terminal, comprising:
a receiver that receives a transmission signal transmitted by a single base station and addressed to a group that terminals including the information terminal belong to; and
a transmitter that transmits, to the base station, a response signal that stores therein payload data included in the transmission signal, the response signal being receivable by the terminal belonging to the group and being other than the information terminal.

2. The information terminal according to claim 1, wherein
the response signal is a signal used to report to the base station that the transmission signal has been received normally.

3. The information terminal according to claim 1, wherein
the response signal includes information used to identify the group.

4. The information terminal according to claim 1, wherein
when the information terminal is a representative one of the terminals belonging to the group, the transmitter transmits the response signal to the base station.

5. The information terminal according to claim 4, wherein
the response signal includes information used to identify the information terminal corresponding to the representative terminal.

6. The information terminal according to claim 4, wherein
when the group is formed, the representative terminal is selected from the terminals belonging to the group, or
on a basis of at least one of strength of signal reception of each of the terminals belonging to the group, or the remaining capacity of a power source of each of the terminals belonging to the group, the representative terminal is selected from the terminals belonging to the group.

7. The information terminal according to claim 1, wherein
when the receiver fails to receive the transmission signal transmitted by the base station, the receiver receives the response signal addressed to the base station and transmitted by the terminal belonging to the group and being other than the information terminal.

8. The information terminal according to claim 1, wherein
the transmission signal includes information used to identify the base station.

9. The information terminal according to claim 1, wherein
the transmission signal includes information used to identify the terminal belonging to the group.

10. The information terminal according to claim 1, wherein
the terminals used by a single service contractor belong to the group.

11. The information terminal according to claim 1, wherein
the terminals are classified into the groups of respective classes determined on a basis of at least one of the type of the terminal or a function of the terminal.

12. A communication method that is performed by an information terminal, the communication method comprising:
receiving a transmission signal transmitted by a single base station and addressed to a group that terminals including the information terminal belong to; and
transmitting, to the base station, a response signal that stores therein payload data included in the transmission signal, the response signal being receivable by the terminal belonging to the group and being other than the information terminal.

13. A communication apparatus, comprising:
a transmitter that transmits a transmission signal to a group that terminals belong to; and
a receiver that receives a response signal that is a signal transmitted by one of the terminals belonging to the group, the response signal storing therein payload data included in the transmission signal, the response signal being receivable by the terminal belonging to the group and being other than the one of the terminals.

14. The communication apparatus according to claim 13, further comprising
a transmission determination section that determines, when the response signal transmitted by the one of the terminals belonging to the group is received, that the transmission of the transmission signal to the group has been completed normally.
